(19) United States
(12) Patent Application Publication
(10) Pub. No.: US 2022/0198035 A1
(43) Pub. Date: Jun. 23, 2022

(54) METHOD FOR CONTROLLING THE CONFIDENTIALITY OF COMMUNICATIONS WITH USERS

(71) Applicants: Mark Aleksandrovich NECHAEV, Krasnoyarskiy kray (RU); Faisal Ashfaq Satti Mohammad, Islamabad (PK)

(72) Inventor: Faisal Ashfaq Satti MOHAMMAD, Islamabad (PK)

(21) Appl. No.: 17/433,246

(22) PCT Filed: Feb. 25, 2019
(86) PCT No.: PCT/RU2019/000115

§ 371 Date: Aug. 24, 2021

(51) Int. Cl. G06F 21/62; G06Q 50/00

(52) U.S. Cl. CPC G06F 21/62; G06Q 50/01

(57) ABSTRACT

The invention relates to the field of social networks. A user activates a special mode for private communication with another user constituting a communication party, in which mode all of the first user's activity that constitutes the content of said communication (comments on messages and posts, subscription, addition of friends, likes and such like) remains hidden to all other users of the Internet portal or social network who are not party to said communication, except for the communication party. Said user can activate the mode for private communication with another user in a unilateral manner, irrespective of a command from the other user with whom said user communicates. The result is that of allowing any user to control the confidentiality of their communication with another user with respect to all other users who are not communication parties.

### CROSS-REFERENCE TO RELATED APPLICATIONS

This application is a national stage application of the Patent Cooperation Treaty (PCT) international application titled “Method For Controlling The Confidentiality Of Communications With Users”, international application number PCT/RU2019/000115, filed in the Russian Patent Office on Feb. 25, 2019. The specification of the above referenced patent application is incorporated herein by reference in its entirety.

### FIELD OF THE INVENTION

The invention relates to the field of wireless communication networks between an unlimited number of users, including to the area self-organizing wireless communication network. namely social network.

BACKGROUND

A technical solution is known for the foreign patent for invention No. WO2014139850 (priority date Mar. 14, 2013) “Method and System For Maintaining Confidentiality On A Device For Creating Social Networks”. This technical solution is characterized by the fact that it refers to a method of maintaining privacy in social network between devices. Invention refers to a method that allows two social network applications inside two individual user devices that are in dose proximity to peer-to-peer data exchange, find out if they have a common user profile (for example, education, personal interests, biographical information, details, contacts, preferences, etc.) and what user data they share, while maintaining the confidentiality of user data (for example, if they do not share if there is any general user data, then the application should not know which one another application has the information). The following essential features of this the technical solutions coincide with the claimed technical solution “Method for controlling the confidentiality of communications with users”: this method allows maintain the confidentiality of user data for another user.

The closest technical solution (prototype) is the technical the decision on the foreign patent for invention No. US2017353423 (priority date Aug. 8, 2017) “Systems and Methods For Enabling Dialog Amongst Different Participant Groups With Variable and Association-Based Privacy”. This technical solution is characterized by the fact that it is a communication system, through which people can enter into a dialogue with one or more participants of the dialog. Different types of dialog can be presented to different persons based on the viewer's connection with the dialog and(or) based on variable privacy settings related to with a dialog. Dialogues can be initiated as private conversations with participants choosing whether to make the conversation view available to people who are not participants in the dialogue. Tools, such as editing tools, can be provided to the dialog participants to control the availability of the dialog content outside dialog elements. The user interface for displaying the dialog box can be provided to the participants of the dialog, which includes a switch that allows participants to switch between open and closed dialogs views, thereby highlighting the differences in how the dialog is displayed for different audiences. Confidential information based on associations can also be implemented in online forums and in communities with limited access. Such systems that ensure confidentiality can be integrated to receive the content of a dialog with another messaging system and/or to disseminate ideas about privacy-sensitive dialogs in external systems, such as messaging platforms, social networks and search engines. The following essential features of this technical solution coincide with the claimed technical solution “Privacy control method communication with users”: the user can choose whether to make the content of his communication with another user available to persons who are not participants of this communication.

The technical solutions listed above have a number of disadvantages:
the technical solution for the patent for invention No. WO2014139850 does not allow the user can independently choose whether to make his profile available or hidden for another user at one time or another
the technical solution under the patent for invention No. US201733423 does not allow the user (participant of the dialog) to communicate with the data only unilaterally, regardless of the command of another user (participant of the dialog) by the user (participant of the dialog) hidden for persons not participating in this communication (dialogue).

### SUMMARY OF THE INVENTION

A method for controlling the confidentiality of communications with users on an Internet portal or social network

The invention relates to the field of wireless communication networks between an unlimited number of users, including the field of self-organizing wireless communication networks, namely social networks.

The claimed method of controlling the confidentiality of communications with users on an Internet portal or in a social network allows solving the technical problem of insufficient provision in modern Internet portals and social networks of full-fledged control of the confidentiality of their communication by any user with another user for all other users who are not participants in communication.

The present invention is an Invisible, incognito, ghost or any other similar profile mode, action, feature or function, When enabled or activated, any action done by one application user on another application user related content or profile will stay hidden from other users except the User who profile or content belongs to. This is not achievable under normal single privacy setting under any other prior art.

The technical result is achieved by the fact that a particular user having a profile on any online portal or social network, controls the visibility of their actions in the process of communication with another user having a profile on the Internet portal or a social network, wherein the user includes a special hidden mode of communication with another user who is a party to the communication, in which all its action, the content of the communication (comments to posts, the posts, the fact that subscriptions add friends, likes, etc.), remain invisible to all other users of the Internet portal or social network who are not participants in this communication, except for the participant of this communication, and this user can enable the mode of hidden communication with another user unilaterally, regardless of the command of another user with whom he communicates.

### BRIEF DESCRIPTION OF THE DRAWINGS

FIG. 1 illustrates a flowchart of the present disclosure.

### DETAILED DESCRIPTION OF THE INVENTION

In contrast to the above analogues the technical equipment claimed for registration the solution “Method of controlling the confidentiality of communications with users” provides for the possibility for the user to control the confidentiality of the content of his communication with another user for all other users who are not participants in this communication, and this user can control confidentiality unilaterally, regardless of commands of another user with whom he is communicating.

The claimed method of controlling the confidentiality of communications with users allows you to solve the technical problem of insufficient support in modem Internet portals and social networks to fully control the confidentiality of their communication by any user with another user for everyone else users who are not participants in the communication.

Accordingly, the technical result of the claimed technical solution “Method control of the confidentiality of communications with users” consists in the fact that it allows a specific user on any Internet portal, in any social network the network to control the confidentiality of the content of its communication with another user of this Internet portal or this social network from all other users who are not participants in this communication, and this the user can control the privacy unilaterally, without depending on the command of another user with whom he is communicating.

The technical result is achieved by the fact that a specific user who has a profile on any online portal or social network, controls the visibility of their actions in the process of communication with another user who has their profile on the Internet portal or social network, wherein the user includes a special hidden mode of communication with another person, being a party to the communication, in which all his actions make up the contents of this communication (comments, messages, posts, the fact of the subscription, add friends, likes, etc.) are not visible to the all other users of the Internet portal or social network who are not participants of this communication, except for the participant of this communication, moreover, this user can enable the mode of hidden communication with another user on a one-way basis, regardless of the command of the other user with whom he communicates.

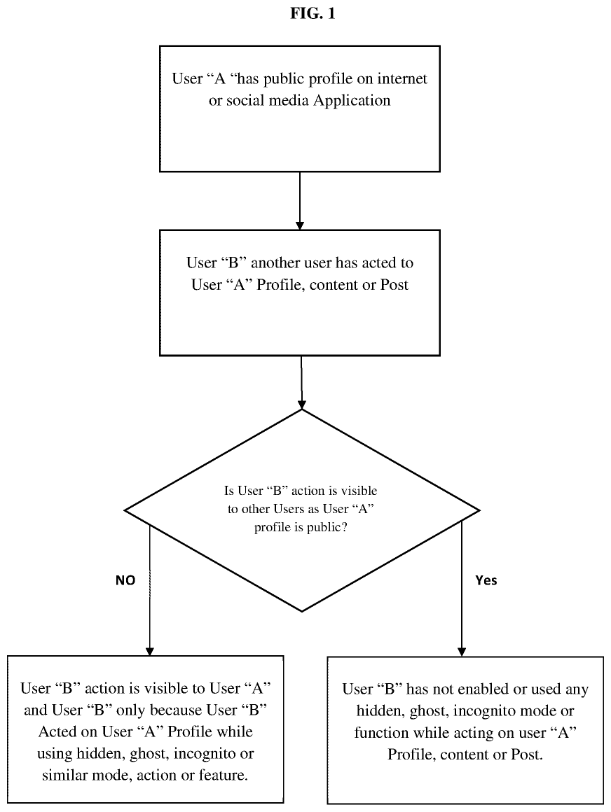

To obtain a technical result, the invention can be carried out as follows. User “A” has profile on social network and profile is public, Which means Any other User can see, User “A” Friend list, User “A” Followers list, User “A” Contact list, User “A” content or post and list of those who have reacted on User “A” content or post by commenting, liking or disliking content etc. Now User “B” is another user, User “B” wants to be friend of User “A”, or wants to follow User “A”, Or wants to have connection with User “A”, Or wants to react on User “A” profile related post or content by commenting, liking or disliking but User “B” does not want other Users to know or see User “B” comment under User “A” content or Post but only wants User “A” to see or know about User “B” comment under User “A” post or content, User “B” does not want other Users to see User “B” in User “A” friends or followers list except User “A” or User “B” itself, User “B” does not want other Users to see User “B” in the content or post like, dislike, subscribe or any similar action based User “A” system Maintained list except User “A” or User “B” itself. Now to hide User “B” from User “A” Profile, content or Post action based system maintained list from other Users Except User “A” or User “B” itself, User “B” will select or enable a hidden, Invisible, incognito, ghost or any other similar mode, action, feature or function before doing any action that will list User “B” in User “A” profile, content or post action based system maintained list. Which will hide User “B” from action based system maintained list of User “A” profile, content or Post from other users, only User “A” and User “B” can see User “B” in User “A” Profile, content or post action based system Maintained list where User “B” has acted also shown in FIG. 1. Now no matter if there is any privacy setting applied or not applied or which type of privacy settings User “A” has applied on his/her profile, content or post etc, now no other User except User “A” and User “B” can see User “B” in the action based system maintained list of User “A” as per User B action. User “B” may able to select or enable hidden, invisible, incognito, ghost or any other similar mode, action, feature or function, before, during or after doing an action.

The presented invention differs in that as a result of the application of this how to control the confidentiality of communications with users on an Internet portal or in a social network, the user can control the confidentiality of the content of his communication with another user for all other users who are not participants in this communication, and this user can control the confidentiality unilaterally, regardless of commands of another user with whom he is communicating.

The present invention is an, Invisible, incognito, ghost or any other similar profile mode, action, feature or function, When enabled or activated, any action done by one application user on another application user related content or profile will stay hidden from other users except the User who profile or content belongs to. This is not achievable under normal single privacy setting under any other prior art. Here the user can control the confidentiality of the content of his communication with another user for all other users who are not participants in this communication, and this user can control the confidentiality unilaterally, regardless of the command of another user with whom he communicates.

I claim:

1. (canceled)

2. A Method of control of confidentiality of communications with users on the Internet portal or a social network, which is characterized as that a specific User who has profile on any online portal or social network, controls the visibility of his/her actions in the process of communication with another user having a profile on the Internet portal or a same social network while doing an action in invisible, hidden, incognito, ghost or any similar hidden mode or action, For Example User “A” has profile on social network and profile is public, Which means Any other User can see, User “A” Friend list, User “A” Followers list, User “A” Contact list, User “A” content or post and list of those who have reacted on User “A” content or post by commenting, liking or disliking content etc. Now User “B” is another user, User “B” wants to be friend of User “A”, or wants to follow User “A”, Or wants to have connection with User “A”, Or wants to react on User “A” profile related post or content by commenting, liking or disliking but User “B” does not want other Users to know or see User “B” comment under User “A” content or Post but only wants User “A” to see or know about User “B” comment under User “A” post or content, User “B” does not want other Users to see User “B” in User “A” friends or followers list except User “A” or User “B” itself, User “W” does not want other Users to see User “B” in the content or post like, dislike, subscribe or any similar action based User “A” system Maintained list except User “A” or User “B” itself. Now to hide User “B” from User “A” Profile, content or Post action based system maintained list from other Users Except User “A” or User “B” itself, User “B” will select or enable a hidden, Invisible, incognito, ghost or any other similar mode, action, feature or function before doing any action that will list User “B” in User “A” profile, content or post action based system maintained list. Which will hide User “B” from action based system maintained list of User “A” profile, content or Post from other users, only User “A” and User “B” can see User “B” in User “A” Profile, content or post action based system Maintained list where User “B” has acted. Now no matter if there is any privacy setting applied or not applied or which type of privacy settings User “A” has applied on his/her profile, content or post etc, now no other User except User “A” and User “B” can see User “B” in the action based system maintained list of User “A” as per User B action. User “B” may able to select or enable hidden, invisible, incognito, ghost or any other similar mode, action, feature or function, before, during or after doing an action.

3. The method of claim 1, wherein a social network user can select hidden profile mode.

4. The method of claim 1, wherein a hidden mode profile user takes action or reacts on public post, content or profile of other user, but all action and reaction of hidden mode profile user are kept hidden to other users except to whom content and profile belongs.
